(19) United States
(12) Patent Application Publication
(10) Pub. No.: US 2015/0122832 A1
(43) Pub. Date: May 7, 2015

(54) SELF-ATTACHING AIR VENT TUBE FOR LIQUIDS AND BEVERAGES TO ACCELLERATE LIQUID FLOW AND REDUCE AGITATION AT A BOTTLE OPENING

(71) Applicant: Eugene James Rodgers, JR., Medfield, MA (US)

(72) Inventor: Eugene James Rodgers, JR., Medfield, MA (US)

(21) Appl. No.: 14/074,564

(22) Filed: Nov. 7, 2013

(51) Int. Cl. B65D 23/04; B67D 3/00

(52) U.S. Cl. CPC B65D 23/04; B67D 3/0051
USPC 222/1; 215/386

(57) ABSTRACT

An air vent tube for liquids and beverages allows air to flow into a bottom portion of a container from which the liquid or beverage is poured. This reduces agitation and congestion that occurs when air attempts to flow into the container opening at the same time the liquid is attempting to flow out of the container opening. The air vent tube is a single open tube with no moving parts that assures the pressure inside the container is equalized with the ambient air pressure. The air vent tube is especially useful, for example, for pouring carbonated beverages from bottles. The air vent tube saves time, reduces the risk of overflow from foaming or head, reduces costs, and results in a more aesthetically appealing pour.

### BACKGROUND OF THE INVENTION

The present invention relates to beverage dispensing tools and, more particularly, to a self-attaching air vent tube for liquids and beverages to accelerate liquid flow and reduce agitation at a bottle opening.

When pouring a beverage, especially carbonated beverages, a significant amount of foam or head can occur if the user attempts a fast pour. Often, pouring carbonated beverages takes time and can result in overflow.

Conventional pouring accessories do not work well because carbonated liquids create pressure when agitated and there is no relief with many conventional devices. This can cause a pressurized squirting effect when the carbonated liquid is poured or the bottle is tilted. This squirting effect increases the amount of foam or head in the resulting pour.

Moreover, many conventional pouring accessories require multiple parts, mechanical reverse flow prevention and stoppers to prevent leaking. These pouring accessories are often significantly more complex and costly to manufacture.

As can be seen, there is a need for a liquid pouring accessory that can simply and easily allow a fast pour from a bottle without producing significant agitation or foam.

### SUMMARY OF THE INVENTION

In one aspect of the present invention, an air vent tube for allowing air flow into a container while pouring liquid from the container comprises an inserted end fitting into the container and extending toward a bottom inside portion thereof; a curved portion fitting about and against a rim of the container; an exterior end extending from the curved portion, the exterior end being disposed outside of the container; and a continuous hollow region inside the air vent tube communicating air flow from outside of the container to the bottom inside portion thereof.

In another aspect of the present invention, an air vent tube for allowing air flow into a container while pouring liquid from the container comprises an inserted end fitting into the container, shaped to fit along an interior surface of the container, and extending toward a bottom inside portion thereof; a curved portion fitting about and against a rim of the container; one or more indentations disposed on the curved portion, the one or more indentations configured to receive raised portions of the rim of the container therein; an exterior end extending from the curved portion, the exterior end being disposed outside of the container; and a continuous hollow region inside the air vent tube communicating air flow from outside of the container to the bottom inside portion thereof.

In a further aspect of the present invention, a method of pouring a liquid from a bottle comprises inserting an inserted end of an air vent tube into the bottle, the inserted end extending toward a bottom inside portion of the bottle; fitting a curved portion of the air vent tube about and against a rim of the bottle; disposing an exterior end of the air vent tube outside the bottle, the exterior end extending from the curved portion; and communicating air flow from outside of the bottle to the bottom inside portion of the bottle during pouring of the liquid from the bottle through a continuous hollow region inside the air vent tube.

These and other features, aspects and advantages of the present invention will become better understood with reference to the following drawings, description and claims.

### BRIEF DESCRIPTION OF THE DRAWINGS

FIG. 1 is a perspective view of a user pouring liquid from a bottle into a container using an air vent tube according to an exemplary embodiment of the present invention;

FIG. 2 is a perspective view of a bottle with an air vent tube inserted therein;

FIG. 3 is a perspective view of the air vent tube used in the bottles of FIGS. 1 and 2;

FIG. 4 is a cross-sectional view taken along line 4-4 of FIG. 1; and

FIG. 5 is a top view of the bottle of FIG. 2, showing the air vent tube inserted therein.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an air vent tube for liquids and beverages that allows air to flow into a bottom portion of a container from which the liquid or beverage is poured. This reduces agitation and congestion that occurs when air attempts to flow into the container opening at the same time the liquid is attempting to flow out of the container opening. The air vent tube is a single open tube with no moving parts that assures the pressure inside the container is equalized with the ambient air pressure. The air vent tube is especially useful, for example, for pouring carbonated beverages from bottles. The air vent tube saves time, reduces the risk of overflow from foaming or head, reduces costs, and results in a more aesthetically appealing pour.

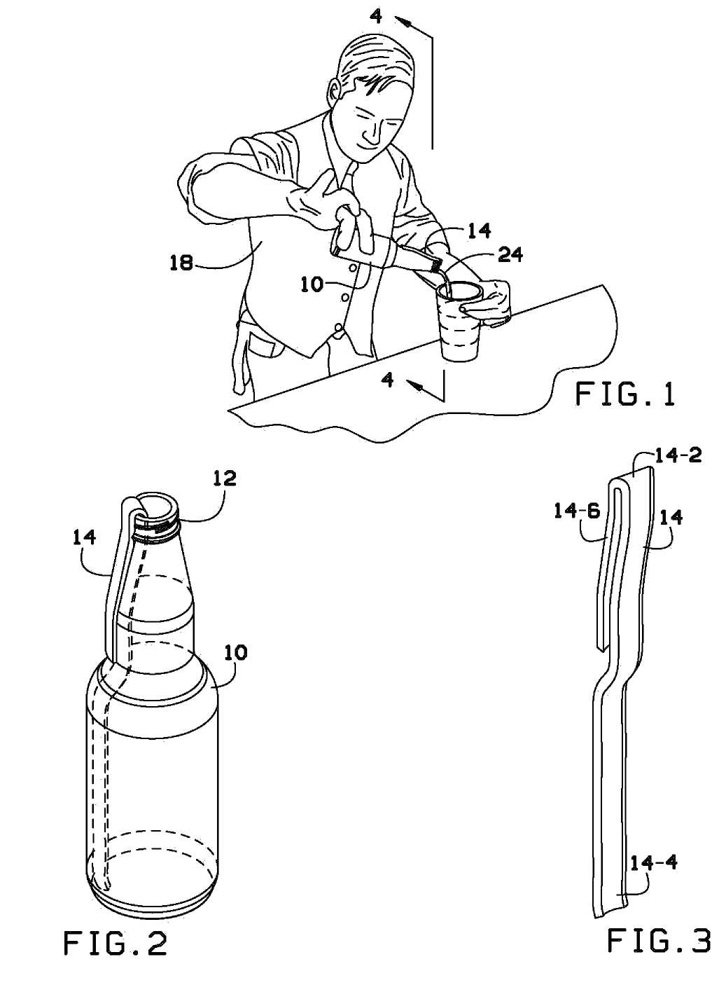

Referring now to FIGS. 1 through 4, a user 18 that desires to pour a liquid 16 from a bottle 10 into a container, such as a glass, can insert an air vent tube 14 into the bottle as shown in FIG. 2, for example.

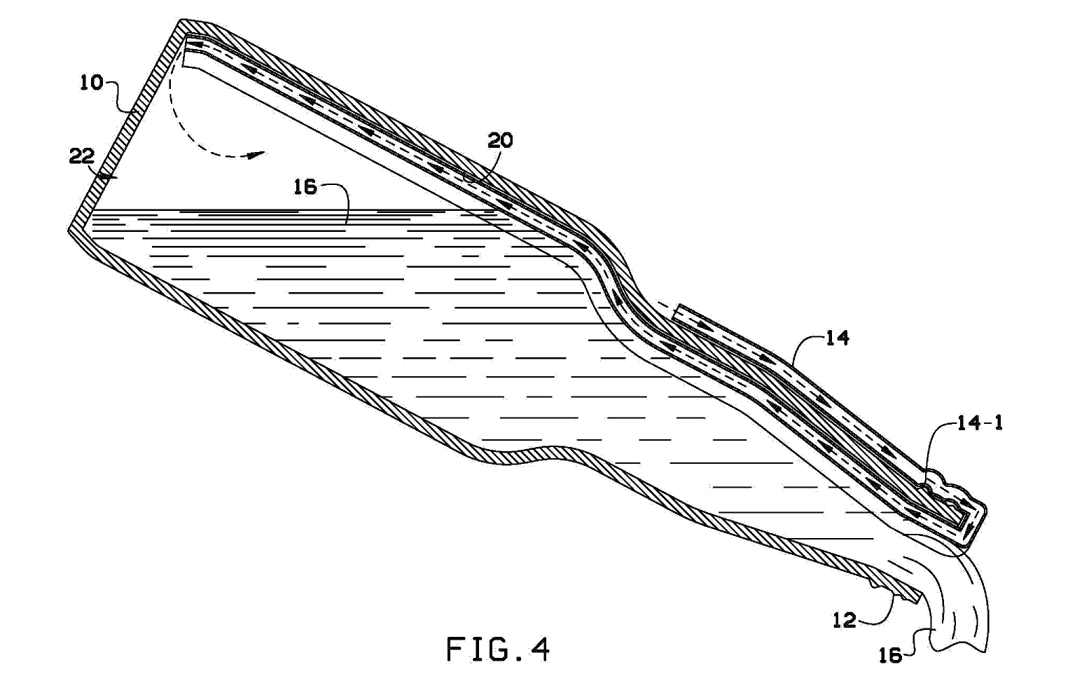

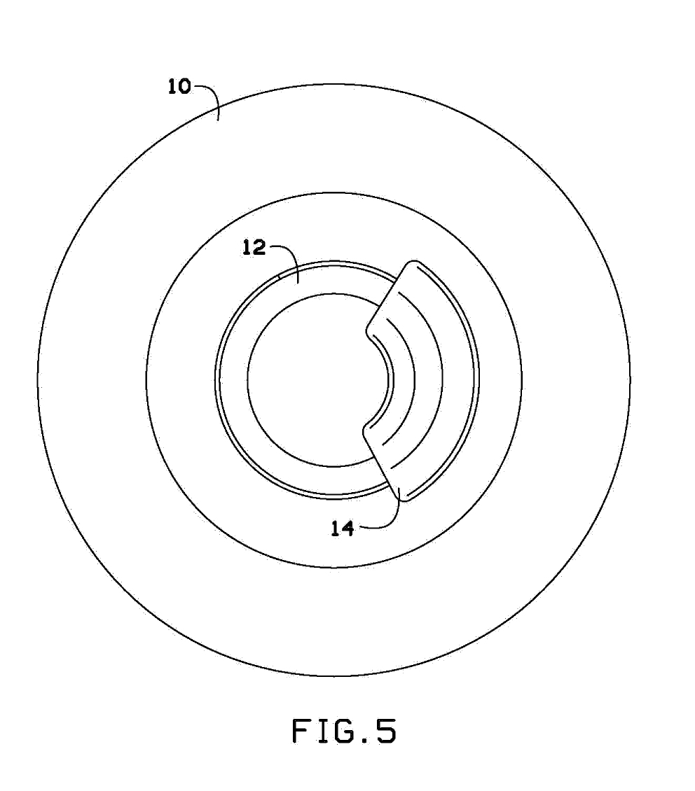

The air vent tube 14 allows air to flow into an inner air cavity 22 at the bottom of the bottle 10 when the user 18 tips the bottle for pouring, as shown in FIG. 4. Air can flow from outside the bottle 10, through the air vent tube 14 and to an interior 20 of the bottle 10, maintaining the inner air cavity 22 at the same pressure as the ambient air pressure and thereby permitting a pour with minimal agitation.

The air vent tube 14 can be designed with a curved end 14-2 that fits about a rim 12 of the bottle 10. The curved end 14-2 can include one or more indentations 14-1 that may grip on the rim 12 of the bottle 10.

An inserted end 14-4 of the air vent tube 14 can extend toward the bottom of the bottle 10 when inserted with the curved end 14-2 fitting about the rim 12 of the bottle. Typically, the inserted end 14-4 extends to the bottom of the bottle 10. A curve may be included on the inserted end 14-4 to prevent the inserted end 14-4 from bottoming out on the bottle 10 and preventing air from flowing into the inner air cavity 22. This curve can be, for example, from about 5 to about 30 degrees.

The air vent tube 14 can have a continuous, hollow interior that allows air to flow from outside the bottle 10 to the inner air cavity 22. The air vent tube 14 can also include various bends to permit the air vent tube 14 to form to the shape of the bottle 10. These curves give rise to the “self-attaching” feature of the air vent tube 14, as, once inserted, the air vent tube 14 can attach itself to the bottle 10 and not fall out during use.

An exterior end 14-6 of the air vent tube 14 can be formed in various lengths and can be designed to extend at least partially down the exterior of the bottle 10, past the rim 12. Typically, this end can be long enough to allow air flow and prevent spillage when the bottle is being poured.

While the drawings show the air vent tube 14 as a generally rectangular, tubular member, the air vent tube 14 can be formed in various cross-sectional shapes. For example, the air vent tube 14 could be designed with a rounded shape, similar to a straw, or with a more square or trapezoidal shape, for example. Various other geometric and non-geometric shapes are contemplated within the scope of the present invention.

The air vent tube 14 of the present invention can be made from various materials and through various processes. In some embodiments, the air vent tube 14 can be made by extruding plastic tubing into a pre-sized shaping mold that conforms to the size and shape of the bottle for which it is intended to be used.

It should be understood, of course, that the foregoing relates to exemplary embodiments of the invention and that modifications may be made without departing from the spirit and scope of the invention as set forth in the following claims.

What is claimed is:

1. An air vent tube for allowing air flow into a container while pouring liquid from the container, the air vent tube comprising:
an inserted end fitting into the container and extending toward a bottom inside portion thereof;
a curved portion fitting about and against a rim of the container;
an exterior end extending from the curved portion, the exterior end being disposed outside of the container; and
a continuous hollow region inside the air vent tube communicating air flow from outside of the container to the bottom inside portion thereof.

2. The air vent tube of claim 1, wherein the inserted end is curved to conform to an interior shape of the container.

3. The air vent tube of claim 1, further comprising one or more indentations disposed on the curved portion, the one or more indentations configured to receive raised portions of the rim of the container therein.

4. The air vent tube of claim 1, wherein the exterior end extends along a portion of an exterior of the container.

5. The air vent tube of claim 1, wherein the container is a bottle.

6. An air vent tube for allowing air flow into a container while pouring liquid from the container, the air vent tube comprising:
an inserted end fitting into the container, shaped to fit along an interior surface of the container, and extending toward a bottom inside portion thereof;
a curved portion fitting about and against a rim of the container;
one or more indentations disposed on the curved portion, the one or more indentations configured to receive raised portions of the rim of the container therein;
an exterior end extending from the curved portion, the exterior end being disposed outside of the container; and
a continuous hollow region inside the air vent tube communicating air flow from outside of the container to the bottom inside portion thereof.

7. The air vent tube of claim 6, wherein the exterior end extends along a portion of an exterior of the container.

8. The air vent tube of claim 6, wherein the container is a bottle.

9. A method of pouring a liquid from a bottle, the method comprising:
inserting an inserted end of an air vent tube into the bottle, the inserted end extending toward a bottom inside portion of the bottle;
fitting a curved portion of the air vent tube about and against a rim of the bottle;
disposing an exterior end of the air vent tube outside the bottle, the exterior end extending from the curved portion; and
communicating air flow from outside of the bottle to the bottom inside portion of the bottle during pouring of the liquid from the bottle through a continuous hollow region inside the air vent tube.

10. The method of claim 9, further comprising locking the curved portion onto the rim of the bottle by allowing at least one raised portion of the rim to fit into at least one indentation of the air vent tube.
